(19) United States
(12) Patent Application Publication
(10) Pub. No.: US 2012/0092416 A1
(43) Pub. Date: Apr. 19, 2012

(54) Metalized Polyimide Aperture Plate And Method For Preparing Same

(75) Inventors: David P. Platt, Newberg, OR (US); Terrance L. Stephens, Molalla, OR (US); John R. Andrews, Fairport, NY (US); Bradley J. Gerner, Penfield, NY (US)

(73) Assignee: Xerox Corporation, Norwalk, CT (US)

(21) Appl. No.: 12/905,561

(22) Filed: Oct. 15, 2010

(51) Int. Cl. B41J 2/14; B05D 5/00; B05D 3/06; B32B 3/10

(52) U.S. Cl. 347/47; 428/137; 427/58; 427/556

(57) ABSTRACT

An aperture plate including a first layer having a first emissivity; a second layer having a second emissivity disposed over the first layer; wherein the first emissivity is higher than the second emissivity; and optionally, at least one additional layer disposed over the second layer. A method for preparing an aperture plate including providing a first layer having a first emissivity; disposing a second layer having a second emissivity over the first layer; wherein the first emissivity is higher than the second emissivity; optionally, disposing at least one additional layer over the second layer; and forming at least one aperture, wherein aperture formation can be before or after disposing the second layer over the first layer. An ink jet print head having an aperture plate including a first layer having a first emissivity; a second layer having a second emissivity disposed over the first layer; wherein the first emissivity is higher than the second emissivity; optionally, at least one additional layer disposed over the second layer; wherein one of the optional at least one additional layers disposed over the second layer is a coating layer for controlling surface tension.

### BACKGROUND

The present disclosure relates to aperture plates. More particularly, the present disclosure relates to aperture plates for ink jet print heads comprising a first layer having a first emissivity; a second layer having a second emissivity disposed over the first layer; wherein the first emissivity is higher than the second emissivity; and optionally, at least one additional layer disposed over the second layer.

Fluid ink jet systems typically include one or more print heads having a plurality of ink jets from which drops of fluid are ejected towards a recording medium. The ink jets of a print head receive ink from an ink supply chamber or manifold in the print head which, in turn, receives ink from a source, such as a melted ink reservoir or an ink cartridge. Each ink jet includes a channel having one end in fluid communication with the ink supply manifold. The other end of the ink channel has an orifice or nozzle for ejecting drops of ink. The nozzles of the ink jets may be formed in an aperture plate that has openings corresponding to the nozzles of the ink jets. During operation, drop ejecting signals activate actuators in the ink jets to expel drops of fluid from the ink jet nozzles onto the recording medium. By selectively activating the actuators of the ink jets to eject drops as the recording medium and/or print head assembly are moved relative to one another, the deposited drops can be precisely patterned to form particular text and graphic images on the recording medium. An example of a full width array print head is described in U.S. Patent Publication 20090046125, which is hereby incorporated by reference herein in its entirety. An example of an ultra-violet curable gel ink which can be jetted in such a print head is described in U.S. Patent Publication 20070123606, which is hereby incorporated by reference herein in its entirety. An example of a solid ink which can be jetted in such a print head is the Xerox ColorQube™ cyan solid ink available from Xerox Corporation.

One difficulty faced by fluid ink jet systems is wetting, drooling or flooding of inks onto the print head front face. Such contamination of the print head front face can cause or contribute to blocking of the ink jet nozzles and channels, which alone or in combination with the wetted, contaminated front face, can cause or contribute to non-firing or missing drops, undersized or otherwise wrong-sized drops, satellites, or misdirected drops on the recording medium and thus result in degraded print quality. Current print head front face coatings are typically sputtered polytetrafluoroethylene coatings. When the print head is tilted, the UV gel ink at a temperature of about 75° C. (75° C. being a typical jetting temperature for UV gel ink) and the solid ink at a temperature of about 115° C. (115° C. being a typical jetting temperature for solid ink) do not readily slide on the print head front face surface. Rather, these inks flow along the print head front face and leave an ink film which can interfere with jetting. For this reason, the front faces of UV and solid ink print heads are prone to wetting by the UV and solid inks.

U.S. Patent Application Number 20100040829, which is hereby incorporated by reference herein in its entirety, describes an aperture plate coated with a composition comprising a fluorinated compound and an organic compound selected from the group consisting of a urea, an isocyanate, and a melamine.

U.S. Patent Application Number 20100149262, which is hereby incorporated by reference herein in its entirety, describes an aperture plate coated with a composition including a first monomer, a second monomer, a fluorinated compound, such as fluorosilane, fluoroalkyl amide, fluorinated either and the like, and a photoinitiator, where the first and second monomer are different.

U.S. patent application Ser. No. 12/625,442, which is hereby incorporated by reference herein in its entirety, describes a coating for an ink jet print head front face, wherein the coating comprises a low adhesion coating, wherein when the low adhesion coating is disposed on an ink jet print head front face surface, jetted drops of ultra-violet gel ink or jetted drops of solid ink exhibit a low sliding angle with the print head front face surface, wherein the low sliding angle is less than about 1° to less than about 30° . In embodiments, the low adhesion coating is an oleophobic coating that exhibits a contact angle of greater than about 35° with ultra-violet gel ink or solid ink.

Maintenance procedures have been implemented in ink jet printers for preventing and clearing ink jet blockages and for cleaning the print head front face. A maintenance procedure for ink jet printers is described in U.S. Patent Publication 20080316247, which is hereby incorporated by reference in its entirety. Examples of maintenance procedures include jetting or purging ink from the ink jet channels and nozzles and wiping the print head front face. Jetting procedures typically involve ejecting a plurality of drops from each ink jet in order to clear contaminants from the jets. Purging procedures typically involve applying an air pressure pulse to the ink reservoir to cause ink flow from all of the jets. The jetted ink may be collected in a waste reservoir such as a spittoon. The purged ink may be collected in a waste reservoir such as a waster tray. A wetted, contaminated print head front face interferes with the collecting of the purged ink by preventing or reducing the ability of the ink to slide over the front face into the waste reservoir. Wiping procedures are usually performed by a wiper blade that moves relative to the nozzle plate to remove ink residue, as well as any paper, dust, or other debris that has collected on the print head front face. An example of a wiper assembly is described in U.S. Pat. No. 5,432,539, which is hereby incorporated by reference herein in its entirety. Jetting/purging and wiping procedures may each be performed alone or in conjunction with one another. For example, a wiping procedure may be performed after ink is purged through the jets in order to wipe excess ink from the nozzle plate.

Solid ink jet print heads have been constructed with stainless steel plates having features that are etched chemically or formed mechanically. Print heads have also been constructed using silicon substrates with microelectro-mechanical systems (MEMS) technology. There has been significant effort to reduce the cost of solid ink jet print heads. One opportunity is to replace the stainless steel aperture plate with a polyimide aperture plate. For stainless steel aperture plates, the apertures were typically mechanically formed. By replacing the stainless steel plate with a polyimide film that can be laser cut, it is possible to eliminate issues with defects and limitations caused by mechanical forming of the stainless steel plate. Further, hole size and size distribution in a polyimide aperture plate can be comparable to stainless steel or improved over that of stainless steel due to the ability to laser cut polyimide. In addition, a polyimide aperture plate can significantly reduce manufacturing costs as compared to a mechanically formed stainless steel plate.

Polyimide is used in many electronic applications for its many advantages, such as high strength, heat resistance, stiffness, and dimensional stability. As noted, in ink jet print heads, polyimide can be used as an aperture plate for ink nozzles. However, polyimide has a higher emissivity than stainless steel, for example, about 0.95 for polyimide versus about 0.4 for polytetrafluoroethylene (PTFE) coated stainless steel, so radiative heat losses with polyimide are about 55% higher than with PTFE coated stainless steel.

Polymer materials, such as polyimide, can be formed into aperture plates using laser ablation with lasers such as excimer lasers. Laser ablation methods can result in an aperture plate that provides excellent drop ejector performance. However, such laser ablatable polymer materials are not typically hydrophobic. It can thus be necessary to provide a hydrophobic coating upon the surface of the aperture plate to render the front face hydrophobic to improve ink jet accuracy and overall performance. Polyimide, however, is not commonly coated. Polyimide is chemically and thermally stable, and many coating materials cannot readily form a thin and uniform coating on a polyimide surface. However, the metallized coating enables used of coatings such as PTFE.

Currently available aperture plates and methods for preparing aperture plates are suitable for their intended purposes. However, a need remains for an improved aperture plate and method suitable for preparing an aperture plate. A need also remains for an improved aperture plate and method for preparing same which can provide a desired emissivity and reduced radiative power losses. Further, a need remains for an improved aperture plate and method for preparing same which can meet Energy-star and TEC (typical electricity consumption) requirements.

### SUMMARY

Described is an aperture plate comprising a first layer having a first emissivity; a second layer having a second emissivity disposed over the first layer; wherein the first emissivity is higher than the second emissivity; and optionally, at least one additional layer disposed over the second layer.

Further described is a method for preparing an aperture plate comprising providing a first layer having a first emissivity; disposing a second layer having a second emissivity over the first layer; wherein the first emissivity is higher than the second emissivity; optionally, disposing at least one additional layer over the second layer; and forming at least one aperture, wherein aperture formation can be before or after disposing the second layer over the first layer.

Also described is an ink jet print head having an aperture plate comprising a first layer having a first emissivity; a second layer having a second emissivity disposed over the first layer; wherein the first emissivity is higher than the second emissivity; optionally, at least one additional layer disposed over the second layer; wherein one of the optional at least one additional layers disposed over the second layer comprises a coating layer for controlling surface tension.

### BRIEF DESCRIPTION OF THE DRAWINGS

FIG. 1 is an illustration of an aperture plate in accordance with the present disclosure.

FIG. 2 is an illustration of a representative example of an aperture formed in an aperture plate in accordance with the present disclosure.

FIG. 3 is a histogram showing aperture size distribution in an aperture plate in accordance with the present disclosure.

FIG. 4 is an illustration of a camera view with a strobe light of ink drops ejecting from an ink jet stack having an aperture plate in accordance with the present disclosure with the camera view directed down the face of the ink jet stack.

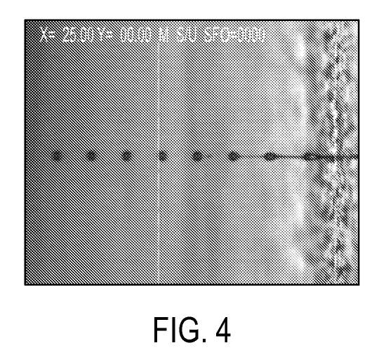

FIG. 5 is a graph showing power consumption (watts, y-axis) versus aperture plate type (x-axis) for an aperture plate in accordance with the present disclosure, a nominal aperture plate comprised of PTFE coated stainless steel, and a polyimide aperture plate.

### DETAILED DESCRIPTION

An aperture plate is provided comprising a first layer having a first emissivity; a second layer having a second emissivity disposed over the first layer; wherein the first emissivity is higher than the second emissivity; and optionally, at least one additional layer disposed over the second layer.

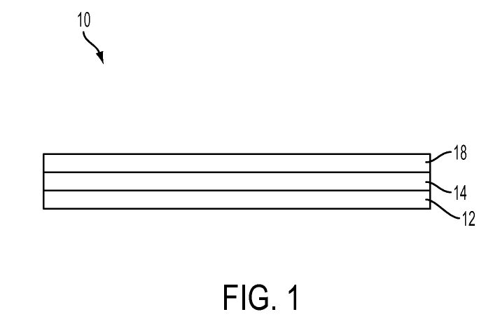

Referring to FIG. 1, an aperture plate 10 is illustrated in accordance with an embodiment of the present disclosure. Aperture plate 10 includes a first layer or substrate 12 having a first emissivity and a second layer 14 disposed on the substrate 12, the second layer 14 having a second emissivity that is different from the first emissivity, and wherein the first emissivity is higher than the second emissivity. Layer 14 can have one or more additional optional coating layers 18 disposed thereon as long as it is also substantially optically transparent to infrared wavelengths. In embodiments, layer 14 can have an optional coating layer 18 disposed thereon, wherein optional coating layer 18 comprises a coating layer for controlling surface tension contact angle.

The aperture plate 10 can be made of any suitable material and can be of any configuration suitable to the device. Aperture plates of square or rectangular shapes are typically selected due to ease of manufacture. The first layer or substrate 12 can be comprised of any suitable or desired material provided that the first layer or substrate 12 has an emissivity which is higher than the emissivity of the second layer 14. For example, in embodiments, the first layer comprises polyimide, polycarbonate, polyester, polyphenylenesulfide, polyetheretherketone, polyetherketone, polyetherketoneketone, polyetherimide, polyethersulfones, polysulfones, liquid crystal polymer, stainless steel, steel, silicon, or a combination thereof. In embodiments, the first layer 12 comprises polyimide, polyether ether ketone, stainless steel, steel, silicon, or a combination thereof. The first layer 12 can also be made of stainless steel selectively plated with a braze material such as gold. In a specific embodiment, the first layer 12 is a polyimide layer.

The first layer 12 can be any suitable thickness. In embodiments, the first layer 12 is from about 8 to about 75 micrometers, or from about 13 to about 50 micrometers, or from about 25 to about 38 micrometers thick. In a specific embodiment, the first layer 12 is about 25 micrometers thick.

The second layer 14 can be comprised of any suitable or desired material provided that the second layer 14 has an emissivity which is lower than the emissivity of the first layer 12. In embodiments, the second layer 14 comprises a metal or a metal alloy such as aluminum, nickel, gold, silver, copper, chromium, titanium, tungsten, zinc, or a combination thereof. In a specific embodiment, the second layer 14 comprises aluminum.

In embodiments, the first layer comprises polyimide, polycarbonate, polyester, polyetherketone, polyetherimide, polyethersulfone, polysulfone, liquid crystal polymer, stainless steel, steel, silicon, or a combination thereof; and the second layer comprises aluminum, nickel, gold, silver, copper, chromium, titanium, or a combination thereof.

In a specific embodiment, the first layer 12 comprises polyimide; and the second layer 14 comprises aluminum.

The second layer 14 can be any suitable thickness. In embodiments, the second layer 14 is from about 0.1 to about 50 micrometers, or from about 0.1 to about 0.3 micrometers, or from about 900 to about 1,100 Angstroms thick. In embodiments, the second layer can be a sub-micron aluminum layer.

Emissivity is the relative ability of a material's surface to emit energy by radiation. The more reflective a material is, the lower its emissivity. A low emissivity material radiates, or emits, low levels of radiant energy. A perfect reflector, that is, a non-emitting material, would in theory have an emissivity of 0. A perfect absorber, that is, a black body, would have an emissivity of 1. An aperture plate is provided herein comprising a first layer having a first emissivity; a second layer having a second emissivity disposed over the first layer; wherein the first emissivity is higher than the second emissivity. The emissivity of the first and second layers can be any suitable emissivity for the intended device.

In embodiments, an aperture plate is provided wherein the first layer is a high emissivity layer having an emissivity of from about 0.4 to about 0.95, or from about from about 0.7 to about 0.95, or from about from about 0.85 to about 0.95; and wherein the second layer is a low emissivity layer having an emissivity of from about 0.02 to about 0.3, or from about from about 0.02 to about 0.2, or from about from about 0.02 to about 0.1.

In embodiments, the first layer has an emissivity of from about 0.4 to about 0.95 and the second layer has an emissivity of from about 0.02 to about 0.3. In further embodiments, the first layer has an emissivity of from about 0.7 to about 0.95 and the second layer has an emissivity of from about 0.02 to about 0.2. In a specific embodiment, the first substrate layer has an emissivity of about 0.95 and the second low emissivity layer has an emissivity of about 0.04.

In embodiments, the low emissivity layer (for example, metallized layer) provides a surface having an improved emissivity over previous aperture plates thereby lowering radiative power losses. In embodiments, the low emissivity layer is an aluminum layer wherein the emissivity is less than about 0.1 and reduces the radiative power losses by about 75% over standard stainless steel and by about 90% over raw polyimide. In embodiments, aluminum metallization of polyimide at less than or equal to about 1 micrometer aluminum thickness enables a laser drilling process that can cleanly remove metal and create high quality apertures thereby enabling excellent directionality and robust jetting performance.

The aperture plate can have at least one additional layer 18 disposed over the second layer 14. In embodiments, the aperture plate can have at least one additional layer 18 disposed over the second layer 14 wherein the additional layer 18 comprises a coating layer for controlling contact angle. In embodiments, the aperture plate can have at least one additional layer 18 disposed over the second layer 14 wherein the additional layer 18 comprises a coating layer for controlling contact angle and wherein the contact angle is from about 35° to about 120°.

The at least one additional layer 18 disposed over the second layer can comprise any suitable or desired material. In embodiments, the at least one additional layer 18 comprises a fluoropolymer or siloxane polymer. In a specific embodiment, the at least one additional layer 18 comprises polytetrafluoroethylene.

The optional additional layer 18 can be any suitable thickness. In embodiments, the layer 18 is from about 400 to about 2,000, or from about 650 to about 1,350, or from about 900 to about 1,150 Angstroms thick.

In embodiments, the additional layer 18 provides contact angle characteristics such that satellite droplets of UV gel ink and solid ink, for example 3 microliter drops of UV ink and 1 microliter drops of solid ink, landing on the aperture plate exhibit a contact angle of from about 35° to about 120°, in specific embodiments a contact angle greater than about 35° or greater than about 55° with the additional layer 18.

The aperture plate herein can be prepared by any suitable or desired method. In embodiments herein, a method for preparing an aperture plate comprises providing a first layer having a first emissivity; disposing a second layer having a second emissivity over the first layer; wherein the first emissivity is higher than the second emissivity; optionally, disposing at least one additional layer over the second layer; and forming at least one aperture, wherein aperture formation can be before or after disposing the second layer over the first layer.

The various layers can be disposed using any suitable process. The layers of the aperture plate can be formed by any suitable method such as physical vapor deposition, chemical vapor deposition, lamination, dip coating, spray coating, spin coating, flow coating, stamp printing, and blade coating techniques.

In embodiments, disposing one or more of the layers comprises disposing by physical vapor deposition, chemical vapor deposition, lamination, dip coating, spray coating, spin coating, flow coating, stamp printing, slot coating, and blade coating, or a combination thereof. In a specific embodiment, physical vapor deposition is used to apply one or more of the layers. In another specific embodiment, physical vapor deposition is used to apply the second low emissivity layer to the first high emissivity substrate layer. In another specific embodiment, physical vapor deposition is used to apply the optional additional coating layer for controlling contact angle to the second low emissivity layer. In still another specific embodiment, physical vapor deposition is used to apply the second low emissivity layer, in embodiments a metal layer, in further embodiments aluminum, to the first high emissivity layer, in embodiments, polyimide. In yet another specific embodiment, physical vapor deposition is used to apply the optional additional coating layer, in embodiments, polytetrafluoroethylene, to the second low emissivity layer, in embodiments, aluminum.

The aperture plate can include one or more holes or ink jet orifices. The holes or orifices can be formed by any suitable method. For examples, the orifices can be cut using any suitable technique, etched, formed mechanically, or created with a laser. In a specific embodiment, forming at least one aperture comprises forming one or more apertures using a laser. Any suitable laser can be used, such as an excimer laser.

Apertures can be formed before or after construction of the aperture plate. In embodiments, apertures can be formed before or after disposing the second layer over the first layer.

Further described is an ink jet print head having an aperture plate comprising a first layer having a first emissivity; a second layer having a second emissivity disposed over the first layer; wherein the first emissivity is higher than the second emissivity; optionally, at least one additional layer disposed over the second layer; wherein one of the optional at least one additional layers disposed over the second layer comprises a coating layer for controlling contact angle.

The aperture plate can be used in any type of print head have any suitable configuration without restriction. Generally, the ink jet print head comprises a plurality of channels, wherein the channels are capable of being filled with ink from an ink supply and wherein the channels terminate in nozzles on one surface of the print head, this surface constituting the aperture plate described herein. Suitable ink jet print head designs are described in U.S. Pat. No. 5,291,225, U.S. Pat. No. 5,218,381, and U.S. Pat. No. 5,212,496, the disclosures of each of which are hereby incorporated by reference herein in their entireties. Another suitable ink jet print head design is described in U.S. Patent Publication Number 2005/0285901, which is hereby incorporated by reference herein in its entirety.

The aperture plates herein can be used with any suitable ink. In embodiments, the aperture plates herein can be used with ink jet inks including dye based inks, pigmented inks, phase change inks, curable inks such as ultraviolet curable inks, and gellant inks.

### EXAMPLES

The following Examples are being submitted to further define various species of the present disclosure. These Examples are intended to be illustrative only and are not intended to limit the scope of the present disclosure.

### Comparative Example 1

A comparative aperture plate was prepared consisting of a non-aluminized polyimide film with apertures formed via laser ablation.

### Example 2

An aperture plate was prepared by the following method. A 0.1 micrometer layer of aluminum was deposited upon a polyimide film (25 micrometers thick) by physical vapor deposition. Aluminized polyimide can be commercially obtained from Sheldahl. A polytetrafluoroethylene layer (0.1 micrometer thick) was deposited over the aluminized polyimide film by physical vapor deposition. Apertures were created by excimer laser ablation at 248 nanometers.

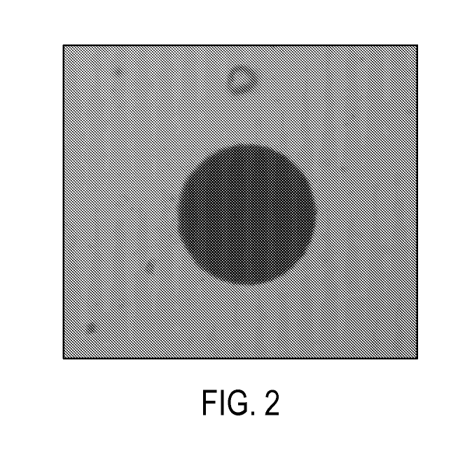

FIG. 2 is a micrograph showing an aperture formed in the aperture plate of Example 2 and illustrates the good roundness and absence of any residual metal.

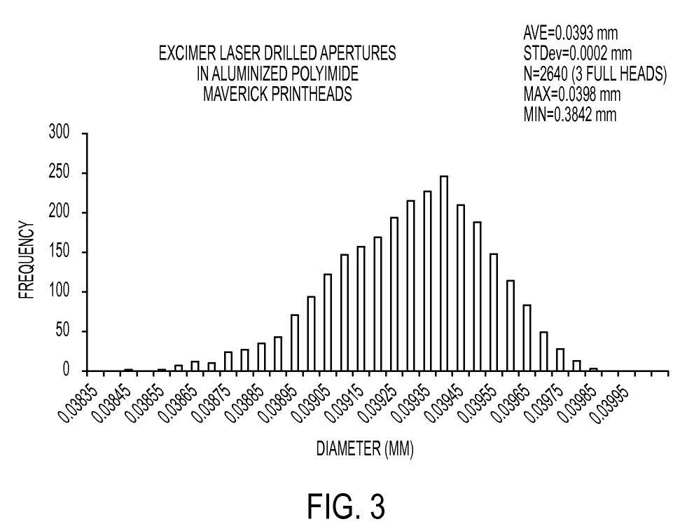

An important measure of quality can be determined from the measured distribution in aperture size. Three aperture plates prepared as in Example 2 having 880 apertures each were measured on a coordinate measuring microscope. FIG. 3 is a histogram showing aperture size distribution for the aluminized polyimide aperture plates prepared in accordance with Example 2. An average diameter of 39.3 micrometers±0.2 micrometer (1σ) This distribution in aperture size is similar to that obtained with uncoated polyimide and suitable for the requirements of normal print head use.

FIG. 3 is an illustration of a camera view with a strobe light of solid ink drops ejected from an ink jet stack of a piezoelectric ink jet printer having an aperture plate in accordance with Example 2 with the camera view directed down the face of the ink jet stack. It can be seen that the solid ink jet droplets were of a suitable size and quality and the aluminized coating did not adversely affect jetting.

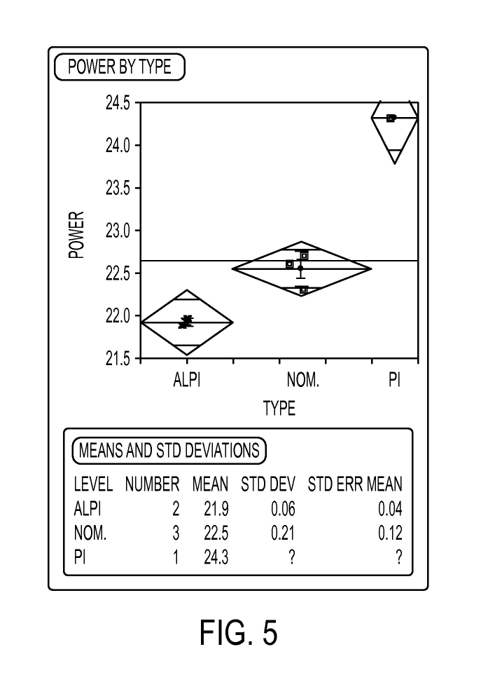

FIG. 5 is a graph showing power consumption (watts, y-axis) versus aperture plate type (x-axis) for an aluminized polyimide aperture plate in accordance with Example 1, a nominal aperture plate comprising PTFE coated stainless steel, and a comparative polyimide aperture plate of Comparative Example 1. In embodiments herein, the present aluminized aperture plate provides power usage benefits over previously available aperture plates.

Improved aperture plates for ink jet print heads, in embodiments, piezoelectric ink jet print heads, are provided. In embodiments, the aperture plate provides improved adhesion and emissivity characteristics over previous aperture plates. The method enables improved adhesion so that standard polytetrafluoroethylene processes can be used with polyimide substrate aperture plate. In embodiments, the present aperture plates can be used with and provide improved adhesion for, anti-wetting coatings. In a specific embodiment, the aperture plate includes a polyimide layer or other suitable substrate layer, a sub-micron aluminum layer or other suitable low emissivity layer disposed on the polyimide layer, and a polytetrafluoroethylene or other suitable layer disposed on the aluminum layer. The aluminum coated polyimide enables the polyimide layer to be coated on the aperture plate with ease and good adhesion as compared to bare polyimide. Further, the polytetrafluoroethylene coating is mechanically stronger than that on current print heads, thereby reducing or eliminating drooling problems that can be experienced with inks, such as pigmented and ultraviolet inks. In embodiments, aluminized polyimide aperture plates provide low emissivity for reduced power consumption.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. An aperture plate comprising:
a first layer having a first emissivity;
a second layer having a second emissivity disposed over the first layer;
wherein the first emissivity is higher than the second emissivity; and
optionally, at least one additional layer disposed over the second layer.

2. The aperture plate of claim 1, wherein the first layer has an emissivity of from about 0.4 to about 0.95; and
wherein the second layer has an emissivity of from about 0.02 to about 0.3.

3. The aperture plate of claim 1, wherein the first layer comprises polyimide, polycarbonate, polyester, polyphenylenesulfide, polyetheretherketone, polyetherketone, polyetherketoneketone, polyetherimide, polyethersulfones, polysulfones, liquid crystal polymer, stainless steel, steel, silicon, or a combination thereof.

4. The aperture plate of claim 1, wherein the second layer comprises a metal or a metal alloy.

5. The aperture plate of claim 1, wherein the second layer comprises aluminum, nickel, gold, silver, copper, chromium, titanium, tungsten, zinc, or a combination thereof.

6. The aperture plate of claim 1, wherein the first layer comprises polyimide; and
wherein the second layer comprises aluminum.

7. The aperture plate of claim 1, wherein the at least one additional layer disposed over the second layer comprises a coating layer for controlling contact angle.

8. The aperture plate of claim 1, wherein the at least one additional layer disposed over the second layer comprises a coating layer for controlling contact angle, wherein the contact angle from about 35° to about 120°.

9. The aperture plate of claim 1, wherein the at least one additional layer disposed over the second layer comprises a fluoropolymer or a siloxane polymer.

10. The aperture plate of claim 1, wherein the at least one additional layer disposed over the second layer comprises polytetrafluoroethylene.

11. A method for preparing an aperture plate comprising:
providing a first layer having a first emissivity;
disposing a second layer having a second emissivity over the first layer;
wherein the first emissivity is higher than the second emissivity;
optionally, disposing at least one additional layer over the second layer; and
forming at least one aperture, wherein aperture formation can be before or after disposing the second layer over the first layer.

12. The method of claim 11, wherein the first layer has an emissivity of from about 0.4 to about 0.95; and
wherein the second layer has an emissivity of from about 0.02 to about 0.3.

13. The method of claim 11, wherein the first layer comprises wherein the first layer comprises polyimide, polycarbonate, polyester, polyphenylenesulfide, polyetheretherketone, polyetherketone, polyetherketoneketone, polyetherimide, polyethersulfones, polysulfones, liquid crystal polymer, stainless steel, steel, silicon, or a combination thereof; and
wherein the second layer comprises aluminum, nickel, gold, silver, copper, chromium, titanium, tungsten, zinc, or a combination thereof.

14. The method of claim 11, wherein the first layer comprises polyimide; and
wherein the second layer comprises aluminum.

15. The method of claim 11, wherein the at least one additional layer disposed over the second layer comprises a coating layer for controlling contact angle; and
wherein the contact angle is from about 35° to about 120°.

16. The method of claim 11, wherein the at least one additional layer disposed over the second layer comprises a fluoropolymer or a siloxane polymer.

17. The method of claim 11, wherein disposing one or more of the layers comprises disposing by physical vapor deposition, chemical vapor deposition, lamination, dip coating, spray coating, spin coating, flow coating, stamp printing, slot coating, blade coating, or a combination thereof.

18. The method of claim 11, wherein forming at least one aperture comprises forming one or more apertures using a laser.

19. An ink jet print head having an aperture plate comprising:
a first layer having a first emissivity;
a second layer having a second emissivity disposed over the first layer;
wherein the first emissivity is higher than the second emissivity;
optionally, at least one additional layer disposed over the second layer;
wherein one of the optional at least one additional layers disposed over the second layer comprises a coating layer for controlling contact angle.

20. The ink jet print head of claim 19, wherein the first layer has an emissivity of from about 0.4 to about 0.95; and
wherein the second layer has an emissivity of from about 0.02 to about 0.3.
